(19) United States
(12) Patent Application Publication
(10) Pub. No.: US 2019/0118513 A1
(43) Pub. Date: Apr. 25, 2019

(54) Packaging Laminate Having a Carrier Layer and a Polyolefin Layer

(71) Applicant: Constantia Teich GmbH, Weinburg (AT)

(72) Inventors: Martin Kornfeld, Klosterneuburg (AT); Robert Kitzberger, Traismauer (AT); Helmut Resch, Rabenstein (AT); Jasmin Teubenbacher, Weinburg (AT); Adolf Schedl, Lilienfeld (AT)

(21) Appl. No.: 16/089,719

(22) PCT Filed: Apr. 3, 2017
(86) PCT No.: PCT/EP2017/057856

§ 371 Date: Sep. 28, 2018

(30) Foreign Application Priority Data
Apr. 4, 2016 (AT) A50271/2016

(51) Int. Cl. B32B 15/085; B32B 27/16; B32B 27/20; B32B 27/32; B32B 7/10; B32B 7/12

(52) U.S. Cl. CPC B32B 15/085; B32B 27/16; B32B 27/20; B32B 27/32; B32B 7/10; B32B 2439/70; B32B 2255/205; B32B 2255/24; B32B 2307/714; B32B 2307/7242; B32B 7/12

(57) ABSTRACT

A packaging laminate including a support layer made of aluminum and a polyolefin layer bonded thereto via an adhesive layer or adhesion promoter layer and having high bond strength. It is provided that the surface of the support layer facing the adhesive layer or adhesion promoter layer includes a modified surface layer produced by silicatization or titanization.

### TECHNICAL FIELD

The present teaching relates to a packaging laminate comprising a support layer and a polyolefin layer bonded thereto, and to a production method for a packaging laminate of this kind. The present teaching also relates to a deep-drawn packaging tray made of a packaging laminate of this kind.

### BACKGROUND

In the packaging industry, film-like laminates are often used as a starting material for producing packagings. Depending on the application, a variety of laminate structures can be used. In many packaging laminates, an aluminum film is used as the support layer, as aluminum ensures excellent product protection, can be worked easily and, in packaging laminates, forms a barrier against external influences. The support layer made of aluminum is usually combined with other layers to form the packaging laminate, it being possible to laminate the other layers with the aluminum layer or to extrude the other layers, in the case of plastics materials, onto the aluminum layer. In the case of laminating, the bond is formed by means of an adhesive.

For use as a packaging laminate, sufficient adhesion between the support layer made of aluminum and a plastics layer bonded thereto is necessary in order to prevent the packaging laminate from being delaminated or manually separated during use. In packaging laminates, polyolefins, such as polypropylene (PP) or polyethylene (PE) of various types, are most commonly used. Therefore, in packaging laminates specific adhesives are used and surface treatments, such as flame treatment, corona treatment, chromating the surface etc., are used, in particular if there are increased requirements for resistance to delamination. Packaging laminates that satisfied the requirements could therefore be produced.

Due to stricter legal requirements for packaging laminates, in particular for packaging foodstuffs, the choice of possible adhesives and/or the options for surface treatment are severely limited.

For example, adhesives that have been used previously, in particular epoxy resin-based adhesives, often contain Bisphenol A. However, Bisphenol A is a Group 3 chemical of the International Agency for Research on Cancer (IARC), i.e. is not classifiable as to its carcinogenicity to humans, and is therefore undesirable in packaging laminates. There are also strict regulations concerning the permissible chrome content in packagings and concerning the handling of chrome compounds. The regulations continue to be tightened. This makes it difficult or impossible to use previous adhesives and surface treatments.

However, other possible adhesives do not achieve the required adhesion between the support layer made of aluminum and the polyolefin layer bonded thereto, in particular when a produced packaging is treated in a sterilization process. Sterilization takes place in an autoclave at typical temperatures of 121° C. and higher and for durations in the range of 30 min (30-45 min). Owing to the sterilization process, but also owing to the filling material in a packaging itself, the adhesive is subjected to stress, which reduces adhesion and resistance to delamination. Therefore, the available adhesives in particular do not offer the required resistance to sterilization. The previous surface treatments for improving adhesion are, using adhesives of this kind, either insufficient, e.g. flame treatment or corona treatment, or are not possible or possible only to a limited extent, such as chromating the surface.

### SUMMARY

One object of the present teaching is therefore to specify a packaging laminate comprising a support layer made of aluminum and a polyolefin layer bonded thereto, and an associated production method, which packaging laminate has sufficient adhesion between these layers.

This object is achieved according to the present teaching by the support layer made of aluminum being bonded to the polyolefin layer via an adhesive layer or adhesion promoter layer, whereas the surface of the support layer facing the adhesive layer or adhesion promoter layer comprising a modified surface layer produced by silicatization or titanization. The production method according to the present teaching is characterized in that an aluminum film as the support layer is titanized or silicatized on a surface, an adhesive is applied to the silicatized or titanized surface, and a polyolefin film is laminated onto the adhesive layer. Alternatively, an adhesion promoter and a polyolefin film are co-extruded onto the support layer. Owing to silicatization or titanization, sufficient bond strength can be produced between the support layer and the polyolefin layer in order to be able to use the composite as a packaging laminate. The modified surface layer increases in particular the anchoring of the adhesive layer to the aluminum of the support layer, as it has been established that the packaging laminate particularly delaminates at the aluminum interface. Highly significantly, sufficient bond strength can therefore be achieved after a sterilization process, in particular also with filling materials or simulants. A simulant is a mixture or a solution that simulates the chemical properties of a filling material. These are, for example, mixtures of oil, vinegar, herbs, citric acid etc. Furthermore, the resistance of the packaging laminate to corrosion can be increased by silicatization or titanization.

The packaging laminate is therefore particularly suitable for the production of packaging trays by means of a deep-draw process. The packaging trays can then be filled with a filling material, sealed and sterilized.

If the polyolefin layer is multi-layered, the properties of the polyolefin layer or the packaging laminate can be adjusted flexibly.

For aesthetic reasons, it is often preferable if a coating layer or a protective layer made of plastics material is provided on the surface of the support layer facing away from the polyolefin layer. In this case, it is also advantageous if the surface of the support layer facing the coating layer or the protective layer comprises a modified surface layer produced by silicatization or titanization, in order to improve the adhesion between the support layer and the coating layer or protective layer in this case, too.

In order to improve the adhesion at the polyolefin layer, too, it is advantageous if the surface of the polyolefin layer facing the support layer is corona or flame pre-treated.

Using a polyurethane adhesive, an acrylate-based adhesive or a polyester-based adhesive can meet the requirements regarding the harmlessness of the adhesive, in particular with regard to food law.

In order to further improve the bond, or to improve protection of the packaging laminate against corrosion, the support layer can comprise a primer layer, whereas a further modified surface layer produced by silicatization or titanization being provided between the support layer and the primer layer.

### BRIEF DESCRIPTION OF THE DRAWINGS

The present teaching is described in more detail in the following with reference to FIGS. 1 to 5, which show exemplary, schematic and non-limiting advantageous embodiments of the present teaching. In the drawings:

FIG. 1 shows a laminated packaging laminate according to the present teaching,

FIG. 2 shows an exemplary production process of a packaging laminate of this kind,

FIG. 3 shows a co-extruded packaging laminate according to the present teaching,

FIG. 4 shows an exemplary production process of a packaging laminate of this kind and

FIG. 5 shows a support layer comprising an additional primer layer.

### DETAILED DESCRIPTION

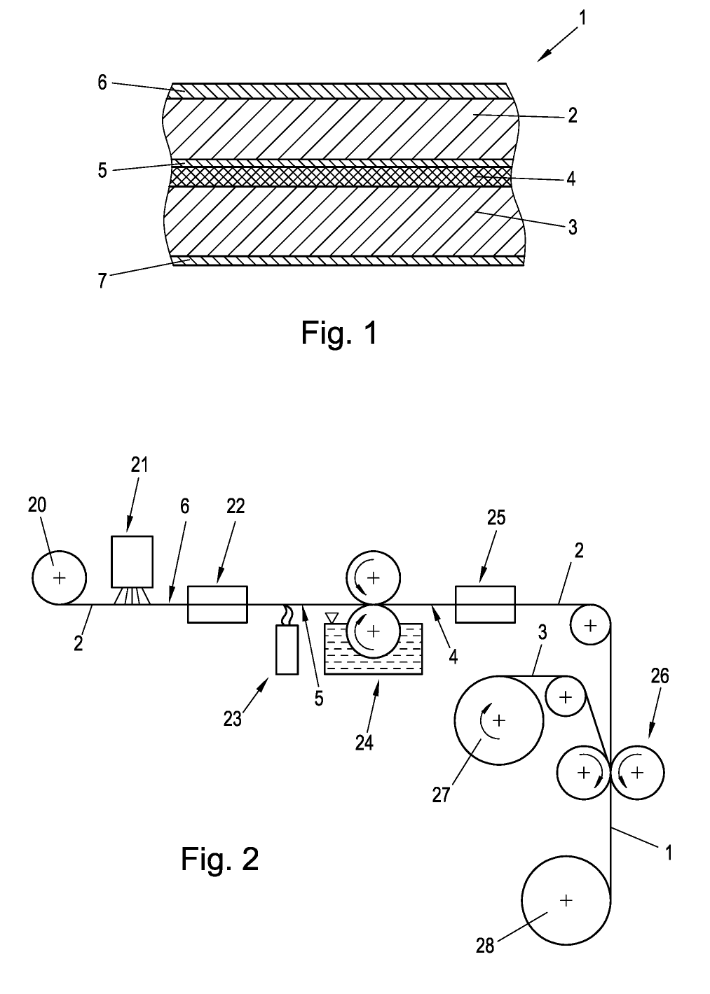

FIG. 1 shows a laminated packaging laminate 1 according to the present teaching comprising a support layer 2 made of aluminum (layer thickness typically 60-160 μm) and a polyolefin layer 3 (layer thickness typically 25-30 μm) bonded thereto, in particular a layer made of cast polypropylene (CPP). Lamination takes place by means of an adhesive layer 4, typically having a layer thickness of 4-8 μm or a basis weight of 4-8 g/m².

According to the present teaching, a polyurethane adhesive system, an acrylate-based adhesive or a polyester-based adhesive, typically as a two-component adhesive, is used as the adhesive for the adhesive layer 4, whereas mixtures of adhesives of this kind are also conceivable. The adhesive could also be colored before application, if required. However, the achievable adhesion between an aluminum layer and a polyolefin layer by means of an above-mentioned adhesive would not be sufficient for the requirements in a packaging laminate 1, in particular in a composite that is resistant to sterilization. The surface of the aluminum support layer 2 facing the polyolefin layer 3 is therefore silicatized or titanized before lamination.

As is known, silicatization or titanization is a surface treatment in the form of flame treatment, in which a silicon compound, such as a silane, or a titanium compounding, as a chemical compound containing titanium, is mixed into the combustion gas-air mixture for producing the flame. The silicon compound or titanium compound produces a thin (several nanometers) modified surface layer 5, such as an SiOx or TiOx layer, that is usually invisible to the naked eye, on the support layer 2, which increases the surface tension and thereby also the bonding properties of the aluminum surface. Silicatization or titanization is known from US 2005/0019580 A1, for example.

Silicatization or titanization improves the bonding properties of the aluminum surface of the support layer 2 so much that sufficient adhesion between the support layer 2 made of aluminum and the polyolefin layer 3 is achieved by means of the above-mentioned adhesives, in particular, the anchoring of the adhesive on the support layer 2 is improved. The bond strength increases by up to 3 N/15 mm in the case of silicatization and by up to 4 N/15 mm in the case of titanization, as has been shown by peel tests. This allows the required bond strength, even after sterilization, of at least 6 N/15 mm, or of at least 5 N/15 mm after being subjected to stress by a filling material or simulant, to be achieved. The associated maximum tear values are approximately 7.5 N/15 mm (with silicatization) and 9 N/15 mm (with titanization).

In a peel test, a test strip of the packaging laminate 1 is pulled apart at free ends of the support layer 2 and the polyolefin layer 3. The free ends are clamped in a pulling machine and pulled apart and the force is thus measured. If the width of the test strip is 15 mm, the bond strength is given as x N/15 mm. The indication of the bond strength is the near-constant peel value and not the maximum tear value that is produced at the beginning of the peel test as a force peak. Typically, a number of peel tests are carried out in order to determine the bond strength and the bond strength is determined as an average value from the individual measurements.

Neither the silicatization nor the titanization produces substances or substance concentrations that would be harmful or prohibited by law in a packaging laminate 1, in particular if used to package foodstuffs. The above-mentioned adhesives are also harmless in packaging laminates 1 and in particular adhesives that do not contain Bisphenol A are available.

The polyolefin layer 3 may also be corona or flame pre-treated, or silicatized or titanized, in a known manner on the surface facing the adhesive layer 4, which increases the bond strength in the packaging laminate 1 at the plastics side, too. The polyolefin layer 3 could also be colored if required.

The polyolefin layer 3 could itself also be multi-layered, e.g. in a co-extruded multi-layered polyolefin film as the polyolefin layer 3. The multi-layered polyolefin film may also contain materials other than polyolefin in central layers. The outer layers of the multi-layered polyolefin film are made of polyolefin, however.

A colored or transparent coating layer 6 may be provided on the surface of the support layer 2 facing away from the adhesive layer 4. Possible coatings for the coating layer 6 are single-component epoxy coating systems or single-component polyester coating systems. Preferably, the coating is applied at a grammage of 2.5 g/m² (dry). Instead of an outer coating layer 6, a protective layer made of plastics material, such as polyester or polypropylene (e.g. cast polypropylene CPP), could be laminated or extruded on the support layer 2.

In order to improve the adhesion between the coating layer 6 or protective layer and the support layer 2, the surface of the aluminum support layer 2 facing the coating layer 6 or the protective layer may be pre-treated by means of silicatization or titanization before a coating is provided, in order to improve the adhesion properties to aluminum there, too.

Both the adhesive for the adhesive layer 4 and, if present, the coating for the coating layer 6 or the plastics material for the protective layer are preferably resistant to sterilization, in order to be able to produce, from the packaging laminate 1, packagings that can be sterilized. In this regard, “resistant to sterilization” means that the required bond strength is not lost in the sterilization process, which typically involves temperatures around 130° C. for durations of around 30 minutes.

The packaging laminate 1 is often deep-drawn to form packaging trays, whereby the coating layer 6 or the protective layer made of plastics material forming the outside of the packaging tray and the polyolefin layer 3 facing the inside of the packaging tray. In this case, the polyolefin layer 3 may also function as a sealing layer for sealing the packaging tray, for example by means of a lid. For this purpose, an oil layer 7 may be applied preferably on the surface of the polyolefin layer 3 facing away from the adhesive layer 4, in order to make the deep-draw process possible. The oil is normally applied shortly before deep-drawing and is spread typically also on the opposing surface of the packaging laminate 1 due to the process. The oil for the oil layer 7 typically consists of (medicinal) white oil and/or glyceryl monooleate and is applied at a grammage of approximately 0.2-1 g/m², preferably 0.5-0.7 g/m². Alternatively, vegetable oils or dissolved vegetable waxes, such as carnauba wax, can be used for this purpose.

FIG. 2 shows a production process, by way of example, for a laminated packaging laminate 1 according to FIG. 1. An aluminum film (support layer 2) is unwound from a roller 20 and (optionally) supplied to a coating unit 21, in which a coating layer 6 is applied to a surface of the support layer 2. The coating layer 6 is dried or polymerized in a subsequent drying channel 22. Subsequently, the opposing surface is silicatized or titanized in a surface treatment unit 23, in order to form the modified surface layer 5 on the aluminum support layer 2. The adhesive is applied to the modified surface layer 5 in an adhesive application unit 24. The applied adhesive is dried in another drying channel 25. As aluminum is bonded to a polyolefin, in principle only dry lamination can be considered, because in the case of wet lamination, the solvent could not evaporate or could not evaporate sufficiently rapidly and blister could form. The support layer 2 treated in this manner is then supplied to a lamination unit 26. At the same time, a polyolefin film (polyolefin layer 3) is supplied to the lamination unit 26 from a roller 27. Lamination is carried out in the lamination unit 26 between a pair of rollers that press the support layer 2 and the polyolefin 3 together. The finished packaging laminate 1 can be wound on a roller 28 and can be further processed from the roller 28. If the finished packaging laminate 1 is to be deep-drawn to form a tray, container or the like, the free surface of the polyolefin layer may be provided with an oil layer 7 before deep-drawing.

The lamination unit 21 can also be omitted, of course, if no coating layer 6 is desired or if the aluminum film already has a protective layer made of plastics material. However, the protective layer made of plastics material in particular could be applied after, or simultaneously with, lamination of the polyolefin layer 3. In this case, the support layer 2 could be silicatized or titanized on both sides.

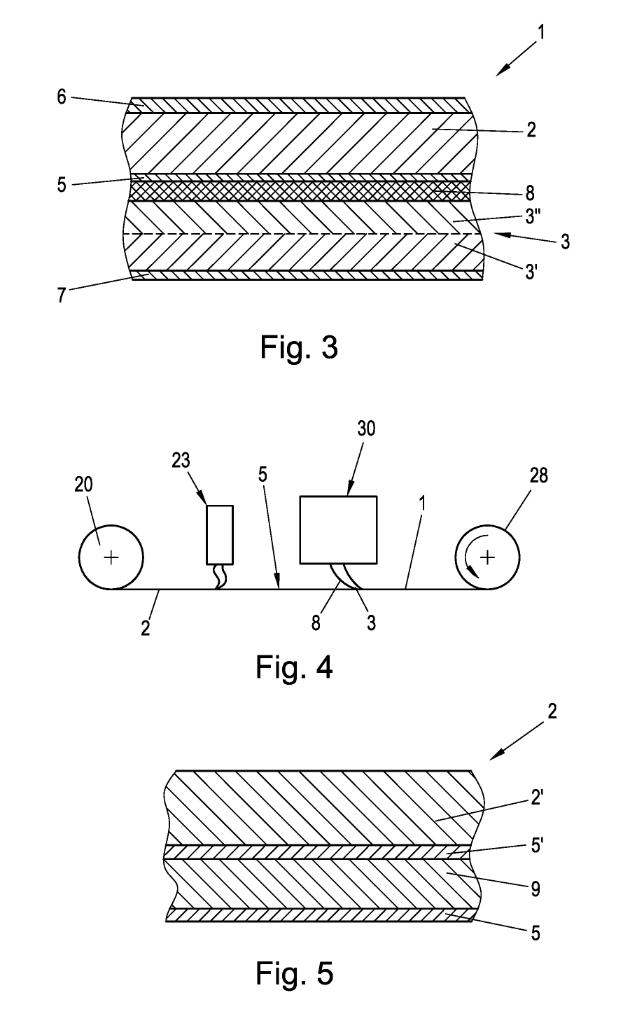

FIG. 3 shows a co-extruded packaging laminate 1 according to the present teaching. In this case, the same layers are designated by the same reference numerals and the same applies as mentioned above for FIG. 1.

The difference in the co-extruded packaging laminate 1 is that an adhesion promoter layer 8 and the polyolefin layer 3 are co-extruded onto the aluminum support layer 2, which is silicatized or titanized on the surface thereof facing the polyolefin layer 3, as described above. This means that the adhesion promoter layer 8 and the polyolefin layer 3 are simultaneously extruded onto the support layer 2 in an extruder. Due to the modified surface 5 of the support layer 2, sufficient bond strength to the support layer 2 can be produced again in the packaging laminate 1.

An adhesion promoter based on polyolefin, preferably made of a modified polypropylene compound, e.g. a maleic anhydride-grafted polypropylene, is preferably used as the adhesion promoter layer 8.

A possible production process of the co-extruded packaging laminate 1 is shown in FIG. 4. In this case, an aluminum film from a roller 20 as the support layer 2 is titanized or silicatized on a surface in a surface treatment unit 23. The opposing surface of the aluminum film on the roller could already be provided with a coating or coated with a protective layer made of plastics material. The aluminum foil could also be provided with a coating before the surface treatment, as shown in FIG. 3, or coated with a protective layer made of plastics material after optional surface treatment. On the side having the modified surface layer 5, the adhesion promoter 8 and a polyolefin layer 3 or a plurality of polyolefin layers 3′, 3″ are extruded in an extruder 30. The packaging laminate 1 can then be wound on a roller 28 again and supplied to further production processes.

The protective layer could also be applied after lamination or after extrusion of the polyolefin film 3 in a subsequent operating step.

Preferably, the adhesion promoter 8 and the polyolefin layer 3 are resistant to sterilization, in order to be able to produce, from the packaging laminate 1, packagings that can be sterilized.

The polyolefin layer 3 of the packaging laminate 1 is preferably a polypropylene (PP) polymer, e.g. from the group of PP homopolymers, PP random copolymers, PP block copolymers, HMS (high melt strength) PP polymers and modified PP polymers. Mixtures of PP polymers of this kind are also possible, wherein the mixture may also contain certain amounts of other polyolefins, such as polyethylene (PE), cyclic olefin copolymers (COC) or thermoplastic polyolefins (TPO). The polyolefin layer 3 may be unfilled, however, it may also contain conventional filling material, such as talc, calcium carbonate (CaCO₃) and the like.

The polyolefin layer 3 itself could be multi-layered both in the laminated packaging laminate 1 and in the co-extruded packaging laminate, as indicated in FIG. 3. For example, a first polyolefin layer 3′ could be co-extruded with a second polyolefin layer 3″ and with the adhesion promoter layer 8. The various polyolefin layers 3′, 3″ can therefore have different properties, depending on application and requirements. A first polyolefin layer 3′ could, for example, be an unfilled polyolefin layer and the second polyolefin layer 3″ could be a filled polyolefin layer.

The outer layer of the polyolefin layer 3 in the packaging laminate 1, in this case the first polyolefin layer 3′, for example, can assume the function of a sealing layer again. This polyolefin layer 3′ can therefore be formulated, for example, such that a more or less secure seal or a seal that can be easily removed by the customer (a peelable seal) is achieved. This also substantially applies to the polyolefin layer 3 in the laminated packaging laminate 1.

In the case of co-extrusion, additional functionalities can be implemented, such as coloring a layer for aesthetic reasons, moisture-absorbing or oxygen-absorbing additives, antimicrobial additives, etc.

Furthermore, the outermost layer of the polyolefin layer 3 may also have specific release properties, in order to reduce or prevent adhesion of filling material, for example, or to improve emptying. This layer may also have surface structures for this purpose, such as embossing. This also substantially applies to the polyolefin layer 3 in the laminated packaging laminate 1.

For particularly aggressive, such as acidic filling materials having a low pH, or fatty filling materials, the support layer 2 may also comprise an additional primer layer 9 for further improving adhesion or resistance to corrosion, as shown in FIG. 5. This applies both to the laminated packaging laminate 1 and to the co-extruded packaging laminate 1. The primer layer 9 would be applied, for example, as an aqueous polymer solution in the form of a single-component, self-curing dispersion, to the silicatized or titanized aluminum base support layer 2′, on which an additional modified surface layer 5′ is provided. The primer layer 9 would then also be silicatized or titanized in order to form the modified surface layer 5 of the support layer 2, whereupon the support layer 2 is bonded to the polyolefin layer 3.

1. A packaging laminate comprising a support layer made of aluminum, which is bonded to a polyolefin layer via an adhesive layer or adhesion promoter layer, wherein the surface of the support layer facing the adhesive layer or adhesion promoter layer comprises a modified surface layer produced by silicatization or titanization.

2. The packaging laminate according to claim 1, wherein the polyolefin layer is multi-layered.

3. The packaging laminate according to claim 1, wherein a coating layer or a protective layer made of plastics material is provided on the surface of the support layer facing away from the polyolefin layer.

4. The packaging laminate according to claim 3, wherein the surface of the support layer facing the coating layer or protective layer comprises a modified surface layer produced by silicatization or titanization.

5. The packaging laminate according to claim 1, wherein the surface of the polyolefin layer facing the support layer is corona or flame pre-treated or silicatized or titanized.

6. The packaging laminate according to claim 1, wherein the adhesive for the adhesive layer is a polyurethane adhesive, an acrylate-based adhesive or a polyester-based adhesive.

7. The packaging laminate according to claim 1, wherein an adhesion promoter based on polyolefin is provided for the adhesion promoter layer.

8. The packaging laminate according to claim 1, wherein the support layer comprises a support layer made of aluminum and a primer layer, whereas a further modified surface layer, produced by silicatization or titanization, being provided between the support layer and the primer layer.

9. A method for producing a packaging laminate in the form of a support layer made of aluminum, which support layer is bonded to a polyolefin layer via an adhesive layer, wherein an aluminum film as the support layer is titanized or silicatized on a surface in order to form a modified surface layer, an adhesive is applied to the silicatized or titanized surface, and a polyolefin film is laminated onto the adhesive layer.

10. A method for producing a packaging laminate in the form of a support layer made of aluminum, which support layer is bonded to a polyolefin layer via a adhesion promoter layer, wherein an aluminum film is titanized or silicatized on a surface in order to form a modified surface layer and a adhesion promoter and a polyolefin film are co-extruded onto the silicatized or titanized surface.

11. The method according to claim 9, wherein a coating layer or a protective layer made of plastics material is applied to the surface of the support layer facing away from the polyolefin layer.

12. The method according to claim 11, wherein the surface of the support layer facing the coating layer or the protective layer is titanized or silicatized.

13. The method according to claim 9, wherein a primer layer is applied to the titanized or silicatized surface layer of the aluminum film, which primer layer is titanized or silicatized and subsequently bonded to the polyolefin layer.

14. A packaging tray produced by deep-drawing a packaging laminate according to claim 1.

15. The packaging tray according to claim 14, wherein an oil for forming an oil layer is applied to at least one surface of the packaging laminate.
